(19) United States
(12) Patent Application Publication
(10) Pub. No.: US 2025/0256264 A1
(43) Pub. Date: Aug. 14, 2025

(54) AMMONIA CARRIER AND METHODS FOR STORING AND RELEASING OF AMMONIA

(71) Applicant: KING ABDULLAH UNIVERSITY OF SCIENCE AND TECHNOLOGY, Thuwal (SA)

(72) Inventors: Anissa BENDJERIOU-SEDJERARI, Thuwal (SA); Swechchha PANDEY, Thuwal (SA); Magnus RUEPING, Thuwal (SA)

(21) Appl. No.: 18/856,418

(22) PCT Filed: Apr. 11, 2023
(86) PCT No.: PCT/IB2023/053690

§ 371 Date: Oct. 11, 2024

Related U.S. Application Data
(60) Provisional application No. 63/330,351, filed on Apr. 13, 2022.

(51) Int. Cl. B01J 20/32; B01J 20/10; C01C 1/02

(52) U.S. Cl. CPC B01J 20/3204; B01J 20/103; B01J 20/3219; C01C 1/02

(57) ABSTRACT

An amine-loaded carrier is loaded with silyl amine groups, and the amine loaded carrier includes a non-porous silica substrate dehydrated or dehydroxylated at a first temperature and the silyl amine groups attached to the dehydrated, non-porous silica substrate at a second temperature, different from the first temperature, so that covalent bonds are formed between a surface of the non-porous silica substrate and the silyl amine groups. The covalent bonds are formed due to a chemisorption process, and the covalent bonds are stronger than van der Waals bonds formed due to a physisorption process.

### CROSS-REFERENCE TO RELATED APPLICATIONS

This application claims priority to U.S. Provisional Patent Application No. 63/330,351, filed on Apr. 13, 2022, entitled “OXIDE MATERIALS FOR CUSTOMIZED AMMONIA STORAGE AND RELEASE,” the disclosure of which is incorporated herein by reference in its entirety.

### BACKGROUND OF THE INVENTION

### Technical Field

Embodiments of the subject matter disclosed herein generally relate to a chemical carrier and methods for storing and releasing ammonia from the carrier, and more particularly, to an inexpensive carrier that can store and release the ammonia in a safe manner.

### Discussion of the Background

Ammonia is produced industrially (144 Mmt of NH₃ produced worldwide in 2020) through the Haber-Bosch process, which converts atmospheric nitrogen (N₂) into ammonia (NH₃) by catalytic reaction with hydrogen (H₂) and an iron-based catalyst under high temperatures and pressures. The process makes ammonia fertilizer globally available, enhancing yields from agriculture rapidly in a short time. The rest of the ammonia helps make pharmaceutics, fine and specialty chemicals.

Due to the push for an economy that does not rely on hydrocarbons as the main source, ammonia finds its way into the fuel field as it can be used as a transport fuel, for example, by engine combustion or by chemically reacting with the oxygen in a fuel cell. In addition, the ammonia can be used as a vector for storing thermal energy due to the energy captured in the transformation from one phase to another phase. As the production and distribution infrastructure of ammonia is already in place and mature, it is likely that this new fuel will be adopted to replace the existing carbon-based fuels.

However, a problem facing the ammonia industry, which has prevented that large scale adoption of this new fuel, is the fact that anhydrous ammonia is a hazardous chemical. In this regard, ammonia exhibits a significant toxicity by inhalation, has corrosive effects on several metals, and is even explosive. At normal ambient conditions, the anhydrous ammonia is a gas. To store it in large quantities, it is either liquefied under pressure (about 10 bar at 25° C.) or is refrigerated (boiling point −33° C.). It can be stored and transported in tanks of carbon steel or Cr—Ni(Mo) steel.

Long distribution routes are deployed between the production sites and the consumers, across continents and oceans. Tremendous amounts of anhydrous ammonia are usually transported as a pressurized liquefied gas by railway in tank cars, by highway in tanker trucks, in agricultural areas in nurse tanks, and also via pipelines traversing through populated areas. All these routes pose a continuous danger to humans and the environment due to the potential leak of the anhydrous ammonia.

As the ammonia demand increases due to its traditional uses in agriculture, and due to its future utilization as an alternative fuel, i.e., ammonia as a COx-free Hydrogen carrier, the development of new materials for its safe storage, transportation and release is critical to its deployment at large scale. Currently, there is a wide range of materials such as silica (aerosol, mesoporous, periodic mesoporous organo-silica (PMOS)), zeolite, porous ionic polymers (PIP), metal-organic frameworks (MOFs), ionic liquid-MOF composites, metal clusters embedded in graphene, etc. that have been used as adsorbent for ammonia for storage, capture and hydrogen carrier. Such storage of ammonia occurs via the physisorption process. Physisorption is the adsorption in which the molecular interactions between the adsorbate molecules and the adsorbent are primarily governed by van der Waals forces. Physisorption is non-specific in nature and is generally regarded as a weak, reversible process governed by competitive adsorption and desorption which takes place at different rates at the heterogeneous surface.

Although the ammonia is “stabilized” in a solid matrix by the current physisorption process, and its toxicity is even minimized, it is still present because the van der Waals interactions are weak, and thus, the adsorbent will release the ammonia in uncontrolled circumstances, for example during a potential fire due to a transport accident.

Therefore, there is an acute need to develop new methods and carriers that are able to handle, store and transport anhydrous ammonia in an inexpensive way, without the constant threat of accidental spilling during transportation, which could cause great harm to those that handle it and also to the environment.

### SUMMARY OF THE INVENTION

According to an embodiment, there is an amine-loaded carrier loaded with silyl amine groups, and the amine loaded carrier includes a non-porous silica substrate dehydrated or dehydroxylated at a first temperature, and the silyl amine groups attached to the dehydrated, non-porous silica substrate at a second temperature, different from the first temperature, so that covalent bonds are formed between a surface of the non-porous silica substrate and the silyl amine groups. The covalent bonds are formed due to a chemisorption process, and the covalent bonds are stronger than van der Waals bonds formed due to a physisorption process.

According to another embodiment, there is a method for transporting amine groups, and the method includes dehydrating or dehydroxylating a non-porous silica carrier at a first temperature, and loading the non-porous silica carrier with silyl amine groups at a second temperature, different from the first temperature, and under vacuum, in presence of an ammonia flow so that covalent bonds are formed between a surface of the non-porous silica carrier and the silyl amine groups. The covalent bonds are formed due to a chemisorption process that happens at the second temperature and the vacuum condition, and the covalent bonds are stronger than van der Waals bonds formed due to a physisorption process.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of water molecules adsorbed on a silica carrier;

FIGS. 2A to 2C schematically illustrate the types of silanol groups on the silica carrier surface;

FIG. 3 is a flow chart of a method for pre-treating the surface of a carrier and loading the surface with silyl amine groups;

FIG. 4 illustrates the Fourier Transform Infrared (FT-IR) spectrum of the carrier when pre-treated at a temperature of about 200° C., and after treating with ammonia at 500° C.;

FIG. 5 schematically illustrates the reaction of the pre-treated carrier and ammonia;

FIGS. 6A and 6B schematically illustrate a reactor used to treat the carrier with ammonia;

FIG. 7A schematically illustrates the formation of a siloxane bridge, from silanol groups, on the surface of a carrier due to a dehydroxylation reaction;

FIG. 7B schematically illustrates the formation of silyl amine groups from the siloxane bridge on the carrier of FIG. 7A;

FIG. 8 illustrates the FT-IR spectrum of the carrier of FIG. 7B;

FIG. 9 illustrates the FT-IR spectrum of the loaded carrier after the chemisorption process;

FIG. 10 schematically illustrates the formation of silyl amine groups on a carrier that was pretreated at about 700° C.;

FIG. 11 illustrates the FT-IR spectrum of the carrier of FIG. 10;

FIG. 12 schematically illustrates the formation of silyl amine and silanol pairs from a carrier pre-treated at about 1100° C.;

FIG. 13 illustrates the FT-IR spectrum of the carrier of FIG. 12 before and after a chemisorption process;

FIG. 14 illustrates a deamination process of a carrier loaded with silyl amine groups;

FIG. 15A illustrates the FT-IR spectrum recorded at room temperature, after the carrier, which was pre-treated at about 200° C., is treated at 500° C., indicating the stability of the loaded carrier;

FIG. 15B illustrates the FT-IR spectrum recorded at room temperature, after the carrier, which was pre-treated at about 200° C., is treated at 1000° C., indicating that the deamination takes place;

FIG. 16 illustrates temperature programmed desorption-mass spectroscopy analysis of the carrier examined in FIGS. 15A and 15B;

FIG. 17 schematically illustrates the deamination process for the carrier pre-treated at about 1100° C.;

FIG. 18 illustrates the FT-IR spectrum of the carrier of FIG. 17 treated at various temperatures;

FIG. 19 illustrates the temperature programmed desorption with a mass spectroscope of the carrier of FIG. 17;

FIG. 20 illustrates the parameters used for the chemisorption process in dilute conditions;

FIG. 21 illustrates the FT-IR spectrum of ammoniation of Si₁₀₀₀ under dilute conditions;

FIG. 22 illustrates the various phases through which the carrier goes to perform a recyclability test;

FIG. 23 is an amination-deamination-reamination-deamination sequence demonstrating the recyclability of the carrier; and

FIG. 24 illustrates the FT-IR spectrum for physisorbed ammonia.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a non-porous silica-based carrier for storing ammonia as amine. However, the embodiments to be discussed next are not limited to a non-porous silica-based carrier, but may be applied to other carriers.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

It will be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

According to an embodiment, a non-porous silica material is pre-treated for removing the adsorbed water from its surface and for generating desired reactive species, which results in the formation of a carrier. Then, the pre-treated carrier is provided into a controlled medium to experience chemisorption of the ammonia. The controlled medium specify a given temperature, amount of vacuum, and exposure time for forming covalent bonds between the surface of the carrier and silyl amine groups. The loaded carrier is then transported to a desired location, where a deamination process is instituted for collecting the ammonia from the carrier. The loaded carrier is very stable at ambient conditions and thus, it is unlikely that the ammonia carried by the carrier can be accidentally released into the environment. As discussed later, the specific conditions for releasing the ammonia from the carrier are unlikely to be naturally found in our environment.

Prior to discussing these carriers and associated methods in more detail, a brief discussion of the differences between silica and porous silica are presented. Silica or silicon dioxide has the chemical formula SiO₂. It does not include organic compounds. The silica is typically found in sand and is most commonly presented in nature as quartz. The mesoporous silica is a form of silica that has a mesoporous structure. The pores of this structure, which are missing in the traditional silica, have a diameter between 2 and 50 nm. However, the process used to obtain the mesoporous silica requires a template made of rods and this process is expensive and time consuming. Various types of mesoporous silica are available in the art, for example, Santa Barbara Amorphous-15 (SBA-15), which is a highly stable mesoporous silica that has a pore diameter between 5 and 15 nm. Another type of silica-based material previously used in the art is the fibrous nano-silica sphere (KCC-1), which has a fibrous surface morphology, high surface area, and high mechanical stability. Another mesoporous material from the silicate family is the Mobil composition of Matter no. 41 (MCM-41), which consists of a regular arrangement of cylindrical mesopores. More information about these substrates can be found in [1-3].

It is noted that all these structures, which have been used previously to store ammonia, are expensive to manufacture, and thus, the non-mesoporous silica offers a cheaper alternative. For this reason, the methods presented herein are discussed with regard to the non-porous silica. However, those skilled in the art would understand that other substrates may be used instead of the non-porous silica, for example, mesoporous materials like SBA, MCM, etc. For example, experiments performed on MCM41 shown that the nitrogen content (i.e., the amount of ammonia chemisorbed) was enhanced from 0.94 wt. % for the silica, to 2.33 wt. % for the MCM as the surface area of the mesoporous materials is higher than the non-porous silica. Other substrates may also be used, as discussed later. According to embodiments discussed herein, the inventors have found a way to use non-porous silica, which is commercially available and cheaper than the mesoporous substrates discussed above, to safely store and release the ammonia. To achieve these features, the substrate needs to be first pre-treated under a first set of certain conditions and then loaded with silyl amine groups (not directly with ammonia), under a second set of certain conditions. In addition, instead of using the physisorption process currently used in the art, the inventors have discovered that a chemisorption process provides far superior stability for the ammonia. Chemisorption is a chemical reaction occurring between the surface of the carrier and the adsorbate (e.g., NH₃) leading to the generation of new chemical bonds at the surface, for example, a covalent bond, which are much stronger than van der Waals interactions present during the physisorption process discussed above.

The release of ammonia is then possible via a deamination process that occurs under specific conditions (temperature, time and vacuum level), as discussed later in more detail. The deamination process is similar to the deamination reaction of an amino acid and to the dehydroxylation process of the silica surface. The use of the deamination process on inorganic surfaces (carrier) for the release of ammonia has not been reported in the art. All these features and/or steps are now discussed in more detail.

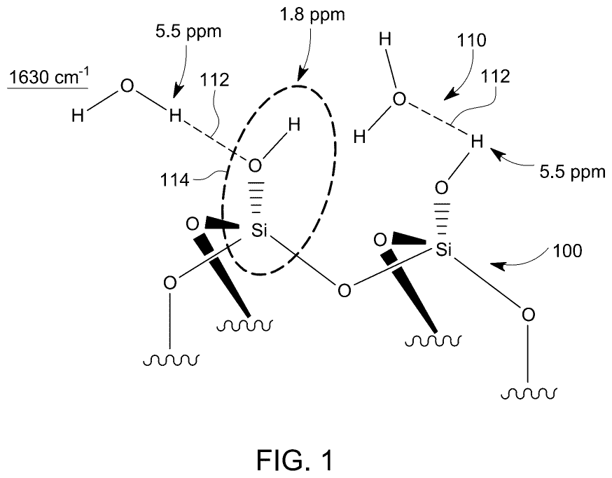

Four differently pre-treated carriers have been found by the inventors to be efficient for storing and releasing ammonia in the form of silyl amine groups. Each of these carriers, also called substrates, is now discussed. To achieve successful chemisorption of ammonia NH₃ on a silica oxide carrier, the temperature, pressure, as well as the reaction time are the parameters that need to be controlled. Besides, a temperature-vacuum or gas flow (Nitrogen) pre-treatment is necessary for the carrier prior to being loaded with the silyl amine groups to remove the adsorbed water from the surface and to generate the reactive species that ultimately generate the amine groups. More specifically, as illustrated in FIG. 1, a silica carrier or carrier 100 is covered with a layer of water (H₂O) 110 through hydrogen interactions 112, under normal temperature and pressure (NTP) conditions. The carrier 100 is a non-porous silica material in this embodiment, i.e., there are no engineered pores in the carrier. However, as discussed above, other materials may be used for the carrier, for example, well-ordered mesoporous silica (SBA15, MCM41, FSM16 . . . ), as well as fibrous silica (KCC-1), which present similar composition as the nonporous silica, ZrO₂, CeO₂, Alumina, zeolites, etc. as long as covalent bonds are formed to generate amine groups on the surface of the carrier during the chemisorption step. These materials are defined as amorphous materials with a framework composed of siloxane bridges (≡Si—O—Si≡) and/or a surface displaying different types of silanol groups (≡Si—OH) 114, as also shown in FIG. 1.

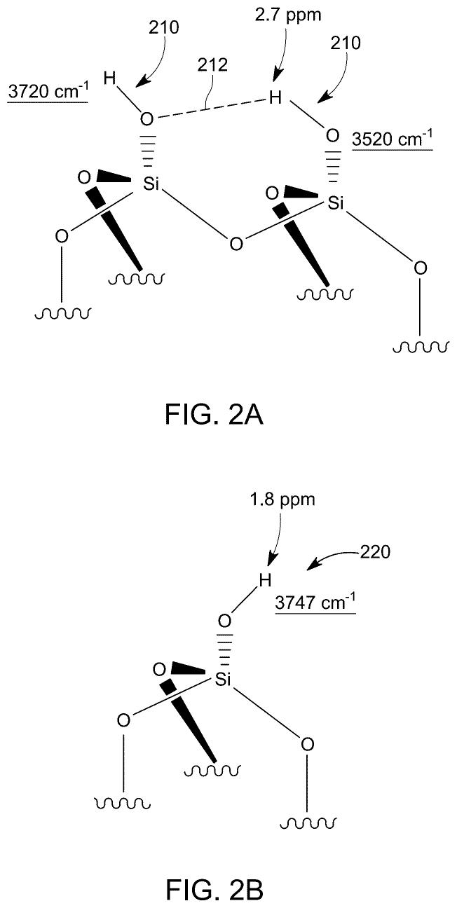

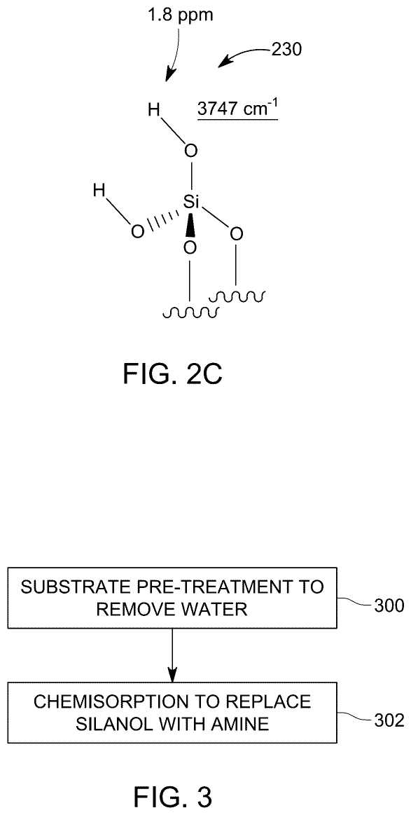

The water molecules 110 are removed from the surface of the carrier 100, according to a first procedure, at about 200° C. and at a vacuum of about 10⁻⁵ to 10⁻⁴ mbar. The term “about” is used in this application to mean up to plus or minus 20% of the value that is characterized by this term. This first treated carrier is called herein SiO₂^{200° C}. or SiO₂²⁰⁰. By pre-treating the carrier 100 at this temperature and pressure, silanols (vicinal 210 as shown in FIG. 2A and single 220 as shown in FIG. 2B) are formed (the reactive elements) and they are heterogeneously distant from each other. In this regard, the pre-treatment of silica at about 200° C. removes the water physisorbed to the surface. Note that the single silanol group 220 and vicinal silanol groups 210 coexist on the surface of the carrier 100 and the vicinal silanol groups 220 are the major species because of the selected temperature and pressure for this step (for example, 75% per mass vicinal versus 25% single). Also note that the vicinal silanol groups 210 imply that two single silanols 220 are close to each other and connected to each other through a force 212, for example, a van der Waals force. A third type of silanol that might exist on the surface of the carrier is the geminal silanol 230, as shown in FIG. 2C. However, this type of silanol is present in a small amount, and thus, can be ignored in the following.

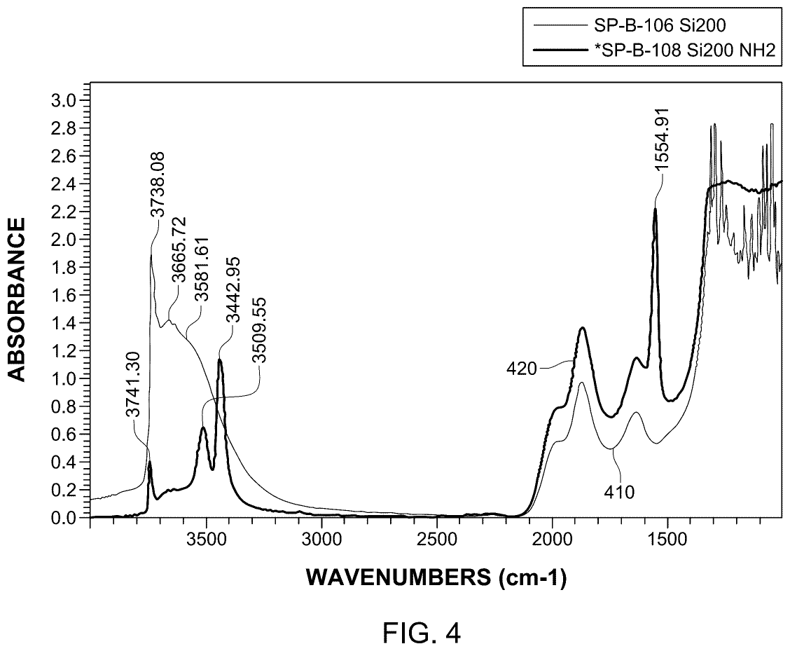

In one application, a step 300 (see FIG. 3) of dehydration of the silica carrier 100 includes processing between 1 and 5 g of the silica material 100 in a quartz reactor and evacuated on a high vacuum line (the term “high vacuum” is understood herein to be a pressure between 10⁻⁵ and 10⁴ mbar). After evacuation, the reactor was properly secured inside a furnace. The silica material was heated at 200° C. for 16 h under a high vacuum to complete the dehydration process. The temperature program used for the process in this embodiment is as follows: from room temperature (RT) to 200° C. within 30 mins (6° C./min step), hold the sample at 200° C. for 16 h and then cool down to RT under high vacuum. The resulting material was then transferred into a glovebox and characterized using FT-IR spectroscopy, as illustrated in FIG. 4. The results shown in FIG. 4 indicate the FT-IR (cm⁻¹) spectrum 410 before the step 300, and the spectrum 420 after the step 300, with the peak 3741 indicating single silanols, and the broad signals at 3665 and 3581 peaks indicating the vicinal silanols (van der Waals interactions).

The inventors have estimated, based on the existing experimental data for the quantification of surface silanols by solid-state ¹H NMR spectroscopy (see, N. Millot et al., Compte Rendu de Chimie 7 (2004) 725-736) that pretreated SiO₂^{200° C}. includes vicinal and single silanol groups of about 0.894 mmol/g, with the single silanol group being about 0.223 mmol/g and the vicinal silanol group being about 0.671 mmol/g, i.e., about 75% vicinal silanol groups 210 and about 25% single silanol groups 220. The distance between the vicinal silanol groups 210 is estimated to be less than 5 Å while the distance between two single silanols 220 is estimated to be more than 5 Å. The vicinal and single silanol groups are randomly distributed on the surface of the SiO₂^{200° C}. carrier and these groups are transformed into the silyl amine groups.

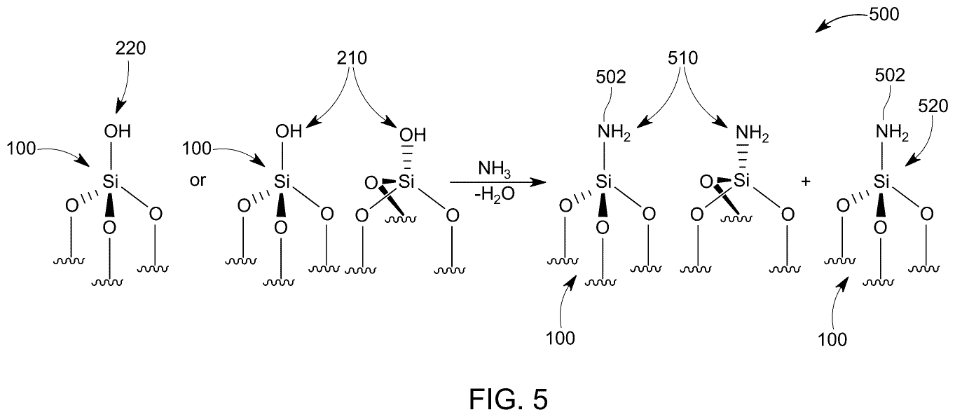

After step 300 of pre-treatment of the carrier 100, a step 302 of chemisorption of the ammonia via the substitution of the silanol groups 210, 220 is performed. FIG. 5 schematically indicates the generation of the single silyl amine groups 520 and vicinal silyl amine groups 510, which resulted from the total substitution of the OH group of the silanols 210 and 220 with NH₂ groups at about 500° C., for 5 h, under a flow of ammonia of 300 ml/min. In this way, the ammonia NH₃ was stored in the carrier 100 as amine. Note that a reverse reaction, which is discussed later, can release the nitrogen atoms 502 to reformulate/recreate the ammonia. A byproduct of step 302 is the formation of water, which is removed with the ammonia flow. The final product 500, i.e., carrier 100 loaded with nitrogen atoms 502, also called “amine loaded carrier,” is a solid material, which is easy and safe to be transported as it is very stable.

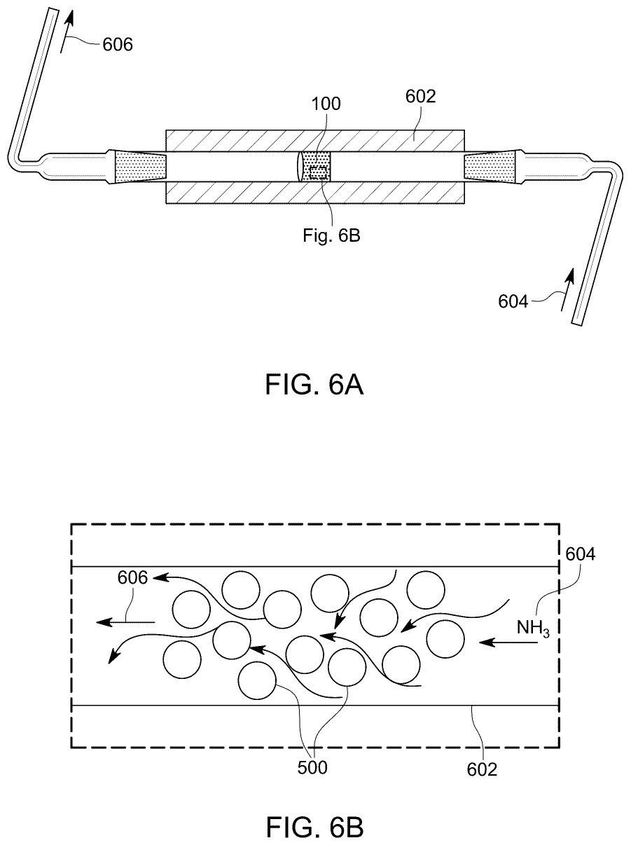

The chemisorption (step 302) of ammonia on the SiO₂²⁰⁰ carrier 100 may use between 1 and 10 g of SiO₂²⁰⁰ 100 in a quartz reactor 602 (see FIG. 6A), which is evacuated on high vacuum prior to connecting to an ammonia reactor. The reactor was filled with N₂ (inert gas) 604 to ensure there is no leak. After this check, the gas 604 was switched from N₂ to NH₃. The unreacted NH₃ and the generated water form a gas flow 606, which is evacuated at an outlet of the reactor. FIG. 6B shows a magnified view of the process taking place inside reactor 602, which results in the final product 500, i.e., carrier 100 loaded with the N atoms 502. The carrier 100 was heated at 500° C. for 5 h under a dynamic flow of ammonia (300 ml/min). After 5 hours, the gas flow was switched back to N₂ and the reactor was allowed to cool down to RT. After this, the reactor was evacuated on high vacuum line overnight. In one application, the temperature program used for the process is as follows: from RT to 500° C. within 30 mins, hold at 500° C. for 5 h and then cool down to RT.

The final product 500 can be described as including an amine carrier 100 loaded with silyl amines 510, 520 for transporting ammonia components. The amine carrier 100 includes a non-porous silica material dehydrated at a first temperature, and vicinal silyl amine groups 520 and single silyl amine groups 520 attached to the dehydrated, non-porous silica carrier 100 at a second temperature, that forms new covalence bonds, which are different from van der Waals bonds due to the chemisorption process. The vicinal silyl amines 510 replace the vicinal silanol groups 210 and the single silyl amines 520 replace the single silanol groups 220 of the dehydrated non-porous silica carrier 100, as illustrated in FIG. 5. In one application, the vicinal silanol groups 510 are about or more than 75% by weight of the total silanols 510 and 520, and a distance between two adjacent vicinal silyl amine groups 510 is smaller than 5Å and a distance between two adjacent single silyl amine groups 520 is larger than 5 Å.

The inventors also discovered that the carrier 100, when heated at about 500 ° C., experiences a dehydroxylation process, that also achieves good stability for the transportation of ammonia. Thus, this embodiment is directed to a second possible carrier. In this embodiment, the operating conditions for the step of dehydroxylation (which can substitute the dehydration step 300 in FIG. 3) of the carrier are as follows. For example, between 1 and 5 g of silica material was taken in a quartz reactor and evacuated on a high vacuum line, e.g., about 10⁻⁵ mbar. After the evacuation step, the reactor was properly secured inside a furnace. The silica material 100 was heated at about 500° C. for 16 h under high vacuum to complete the dehydroxylation process. The temperature program used for the process is as follows: from RT to 500° C. within 30 mins, (15° C./min), hold at 500° C. for 16 h and then cool down to RT under high vacuum.

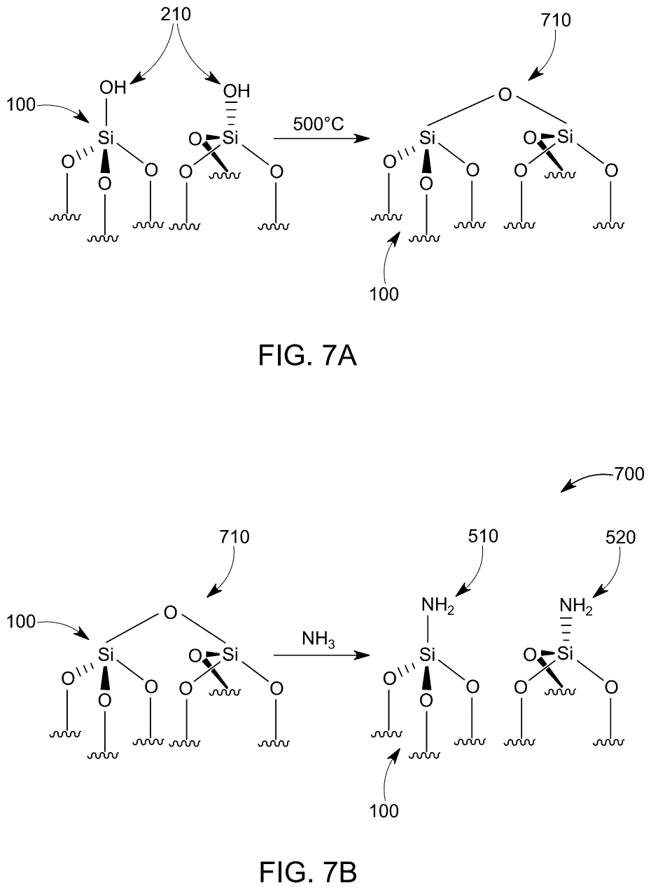

The dehydroxylation process of silica corresponds to the condensation of two silanol surface groups 210 or 220 that are sufficiently close to each other, as shown in FIG. 7A. At the temperature noted above (even up to 700° C.), the dehydroxylation process involves a significant reduction of the number of vicinal silanols [(≡Si—OH)(≡Si—OH)] 210, leading to the formation of siloxane bridges (≡Si—O—Si≡) 710, as show in the figure, with the release of one molecule of water H₂O. This process also involves the creation of isolated or single (≡Si—OH) surface groups 220. Single or isolated silanols are silanol surface groups present onto the surface of the carrier 100, which are sufficiently distant from each other so that no hydrogen interactions formation is formed. Note that a ratio of the single and vicinal silanols for this carrier is about 1:1.

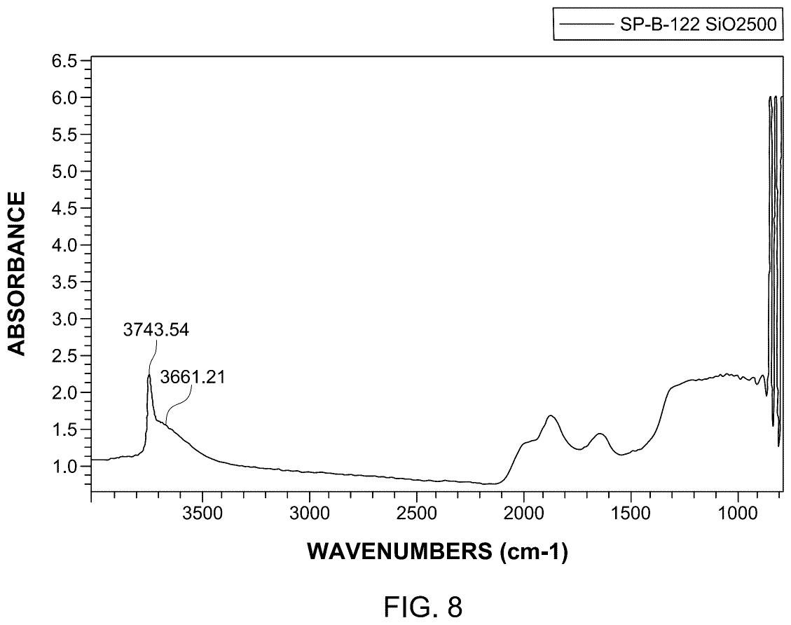

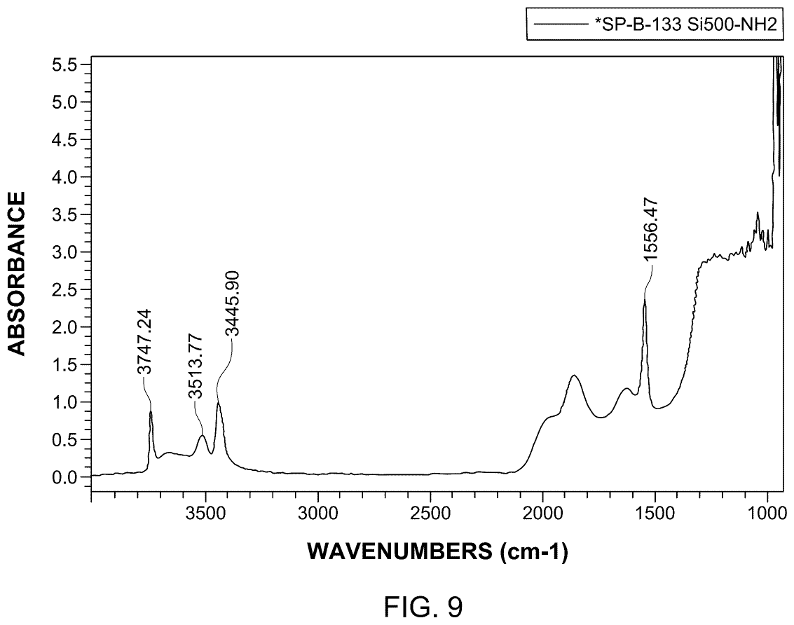

The obtained carrier 100, called herein SiO₂^{500° C}. was transferred into a glovebox and characterized using FT-IR spectroscopy. FIG. 8 shows the FT-IR spectrum of the carrier 100 exhibiting single silanol groups at 3743 and vicinal silanol groups at 3661 cm⁻¹. Next, carrier 100 is exposed to chemisorption of ammonia, which corresponds to step 302 in FIG. 3. In this step, for example, between 1 to 10 g of SiO₂⁵⁰⁰ was weighed in a quartz reactor in glovebox. It was evacuated on high vacuum prior to connecting to the ammonia reactor. The reactor was filled with N₂(inert gas) to ensure that there is no leak. After this gas was switched from N₂ to NH₃, similar to the description of FIGS. 6A and 6B. The carrier 100 was heated at 500° C. for 2 h under dynamic flow of ammonia (300 ml/min). After 2 hours, the gas flow was switched to N₂ and the reactor was allowed to cool down to RT. Then, the reactor was evacuated on a high vacuum line overnight. The temperature program used for the process is as follows: from RT to 500° C. within 30 mins, hold at 500° C. for 2 h and then cool down to RT. The resulting material 700 (carrier 100 with silyl amine groups), which is schematically illustrated in FIG. 7B as having both vicinal 510 and the single 520 silyl amine groups, was transferred into the glovebox and analyzed using FT-IR spectroscopy. Note that during the chemisorption step, the O bridge 710 has been opened and the oxygen was replaced by the silyl amine groups 510 and/or 520. The results of this analysis are shown in FIG. 9, which shows symmetric stretching vₛ(NH₂) at 3445, the asymmetric stretching vₐₛ(NH₂) at 3513, bending vibrations δ(NH₂) at 1554 and the silanol at 3747 cm⁻¹.

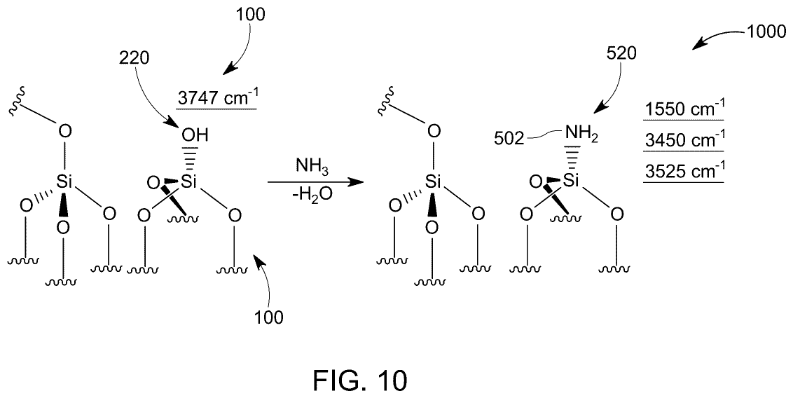

The inventors further investigated a third carrier for being loaded with nitrogen atoms and this carrier uses the carrier 100 but pre-treated at about 700° C. in step 300. This substrate is called herein SiO₂⁷⁰⁰. Different from the previous carriers SiO₂²⁰⁰ and SiO₂⁵⁰⁰, when the pre-treatment of silica occurs at about 700° C. and under high vacuum, only the single silanol groups 220 are the major species remaining on the surface of this third carrier 100, as schematically illustrated in FIG. 10. In other words, silica pre-treated at about 700° C. displays a lower concentration of silanol groups (compared to SiO₂^{200°° C}.), as the silanol groups are present only in single [≡Si—OH] form 220. Thus, in this embodiment, as the percentage of the vicinal silanol is very small, it is practically considered that the third carrier 100 includes only single silanol groups 220. One skilled in the art would understand that some occasional vicinal silanol groups may be present, but their amount is ignored as it is insignificant.

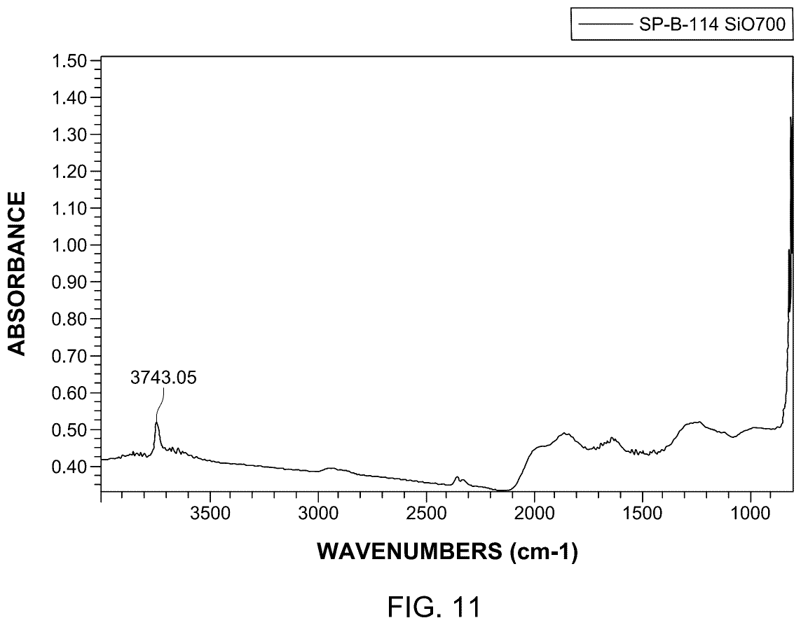

The carrier 100 may be exposed to a process of dehydroxylation at about 700° C. as now discussed. For example, about 1 to 5 g of the silica material 100 was taken in a quartz reactor and evacuated on high vacuum line. After evacuation, the reactor was properly secured inside the furnace. The silica material was heated at about 700° C. for 16 h under high vacuum to complete the dehydroxylation process. The temperature program used for the process is as follows: from RT to 700° C. within 45 mins (15° C./min), hold at 700° C. for 16h and then cool down to RT under high vacuum. The resulting material 1000 was transferred into the glovebox and characterized using FT-IR spectroscopy. As shown in FIG. 11, the FT-IR spectrum (cm⁻¹) shows the presence of the single silanols 220 at about 3743 cm⁻¹. It is noted that the signature of the vicinal silanols is missing.

Next, the carrier SiO₂⁷⁰⁰ 100 is exposed to the process of chemisorption of ammonia in step 302. As illustrated in FIG. 10, the carrier 100 is exposed to NH₃ at about 500° C., for 4 h, at a NH₃ flux of 200 ml/min. During this process, the silanol group 220 is replaced by the single silyl amine group 520 (no vicinal silyl amine groups), as illustrated in the figure, thus forming the final product 1000 (i.e., the silyl amine loaded carrier).

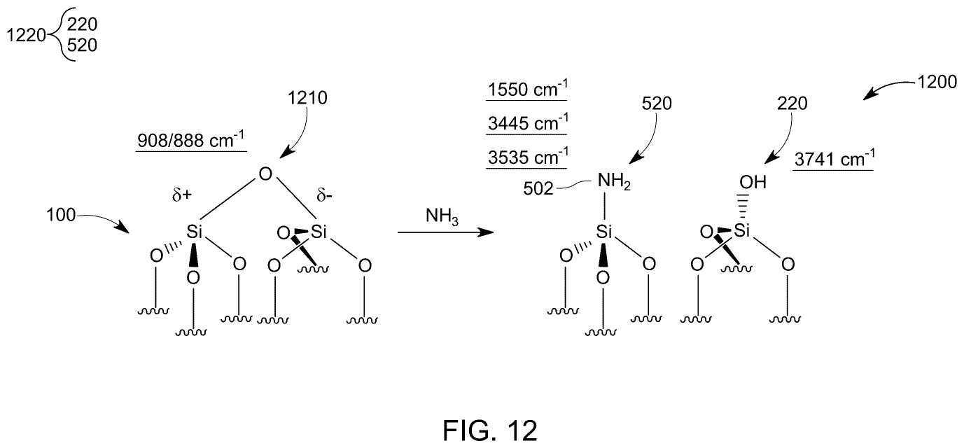

The inventors also considered a fourth carrier for being loaded with nitrogen atoms and this carrier uses the carrier 100 but pre-treated at about 1100° C. in step 300. This carrier is called herein SiO₂¹¹⁰⁰. When the pre-treatment of silica occurs at 1100° C. and under high vacuum, only strained siloxane bridges 1210, ≡Si^{δ+}—O—^{δ-}Si≡ are present as the reactive species, as schematically illustrated in FIG. 12. No single silanol groups 220 are generated at this temperature. Silica 100 pre-treated at 1100° C. displays the highest concentration of strained siloxane bridges 1210 out of all the carriers considered herein. Note that the formation of the strained siloxane bridges 1210 takes place only when the dehydroxylation process takes place at temperatures higher than 800° C. Thus, the carriers from the previous embodiments do not have these bridges. Also, at these pre-treatment temperatures of the carrier 100, the number of silanol groups is significantly reduced, to the point that effectively this number can be considered to be zero when compared to the number of bridges 1210.

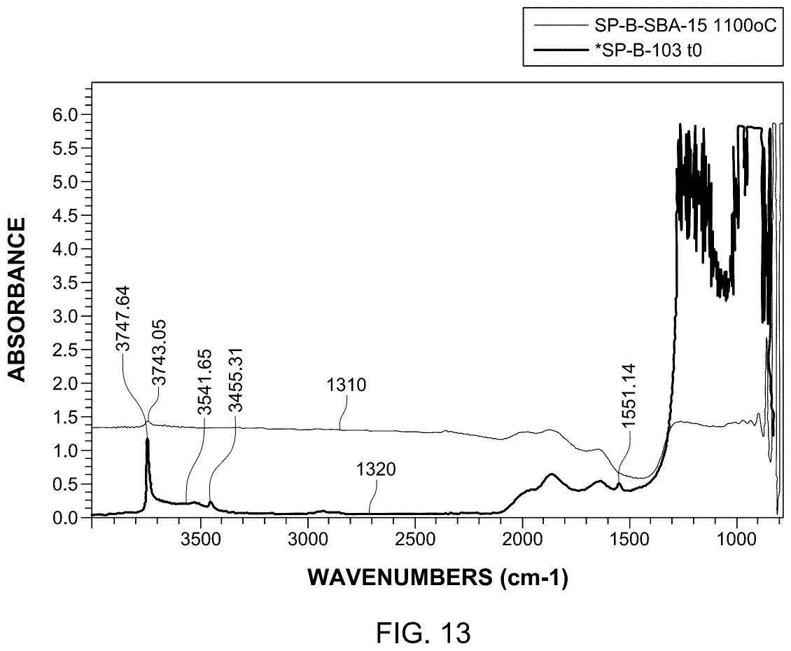

Next, carrier 100 with the bridges 1210 is exposed to NH₃ during a chemisorption process that takes place in step 302. During this process, the temperature is maintained at about 200° C. for about 30 min. and the NH₃ flow during the process is about 300 ml/min. The process may take place in the reactor shown in FIG. 6A. During this process, the bridges 1210 are opened, which results in the formation of the silanol 220 and silylamine 520 pairs 1220 ((≡Si—NH₂) (≡Si—OH)), which are confirmed by FT-IR spectroscopy, as illustrated in FIG. 13. The mechanism by which the siloxane bridges 1210 are opened is mainly identified by an increase of the initial characteristic silanol band, υ(OH) with a redshift from 3748 to 3741 cm⁻¹ associated with the appearance of three new vibration bands at 3535, 3445 and 1550 cm⁻¹ corresponding respectively to υ_{αs}(NH₂), υₛ(NH₂) and δ(NH₂). FIG. 12 shows the FT-IR spectrum 1310 of the carrier and also the FT-IR spectrum 1320 of the amine loaded carrier 1200.

The above discussed embodiments illustrate four differently treated carriers 100, dehydrated at about 200° C. when both vicinal and single silanol groups are formed, dehydroxylated at about 500° C. when the vicinal silanol groups are transformed into siloxane bridges, dehydroxylated at about 700° C., when only single silanol groups are formed, and dehydroxylated at about 1100° C., when all the silanol groups are transformed into strained siloxane bridges. Each carrier was then loaded with silyl amine groups via different mechanisms, but all these processes were performed under controlled temperature, pressure, and NH₃ flux. Note that if any of these three parameters are outside the ranges discussed above, the loading of the carriers may not occur. Also, the NH₃ loading occurs because of the pre-treated carriers at the given temperature and pressure ranges. The inventors have found that the loaded carrier is extremely stable during transportation if these parameters are met.

Once the carrier is loaded, it can be safely transported to any destination, by rail, truck or boat. The danger of releasing ammonia from the loaded carrier is extremely small unless the following conditions are met. These conditions characterize the deamination process, which is now discussed in more detail.

The deamination of the silyl amine loaded carriers NH₂—SiO₂²⁰⁰ 500 and NH₂—SiO₂⁵⁰⁰ 700 are first discussed as these two products include vicinal silyl amine groups, which is not the case for the other amine loaded carriers 1000 and 1200. The deamination process for the products 500, 700, 1000, and 1220 occurs at a high temperature (700 to 900° C. for product 500, 600 to 700° C. for product 700, 500 to 600° C. for product 1000, and about 400° C. for product 1200) under a high vacuum (about 10⁻⁵ to 10⁻⁴ mbar) for 16 hours. From these conditions, it is observed that the chance of the ammonia to naturally be released in gaseous form from the carrier is significantly reduced since a low pressure and high temperature are required. Even if the truck or boat carrying this material is involved in an accident where a fire is present, there is no scenario in which the pressure becomes so small and both the high temperature and the low pressure are sustained at those values for 16 h. This means that the trio of conditions (high temperature, low pressure, and long time) required for the deamination of the specific carriers 500, 700, 1000, and 1200 is very advantageous for keeping the amine groups locked into the carrier, which is desired during the transportation of this material. These extreme conditions for releasing the ammonia from its carrier are necessary for breaking the covalent bonds that were generated during the chemisorption process, as these bonds are much stronger than the van der Waals bonds formed during the traditional physisorption process. In one application, the nitrogen release might occur under a flow of any gas such as N₂, Ar instead of the high vacuum condition discussed above. Thus, the process can also be applied as a gas separation/purification from ammonia.

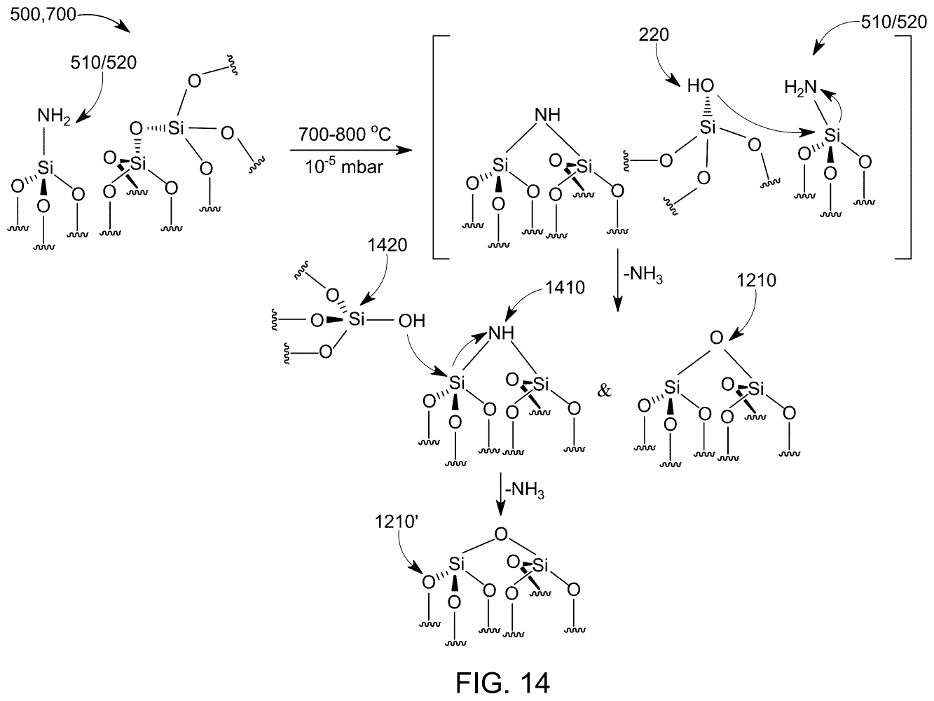

In one deamination experiment, silica material (in pallet form, 60-80 mg) was taken in a quartz reactor equipped with an IR-cell on the top and heated at 400-900° C. (based on amine content present in the material) under a high vacuum for 16 h. The progress of ammonia release from the material was monitored using FT-IR spectroscopy. After the complete desorption, the material was further characterized by various analytical tools such as elemental analysis, FT-IR spectroscopy. A mechanism for deamination is illustrated in FIG. 14, where the product 500/700 includes silyl amine surface groups 510 and/or 520, which react via a closed siloxane bridge 1210 to form a silazane bridge 1410 [≡Si^{δ+}—NH—^{δ-}Si≡] (intermediate product) and a new silanol 1420 [≡Si—OH]. One molecule of ammonia is released during this intermediate step. Then, the newly formed silanol [≡Si—OH] 1420 reacts with another single silyl amine group [≡Si—NH₂)] to form another siloxane bridge 1210′ with the release of another molecule of ammonia.

The process is similar for vicinal silyl amine and single silyl amine group as the silyl amine groups react with the siloxane bridge 1210 to form the silazane bridge 1410 and a silanol 220, after which, the silanol 220 reacts with another silyl amine to release the ammonia. Note that with the amine loaded silica 1200, the deamination process occurs at a low temperature in a one step because the ammonia treatment generated silanol/silyl amine pairs and not vicinal silyl amine groups. The silazane bridge (barely detected by FT-IR spectroscopy) is an intermediate that can also react with silanol to form a silylamine and siloxane bridges. The process is a rearrangement of silica surface (not framework) enabling the liberation of ammonia.

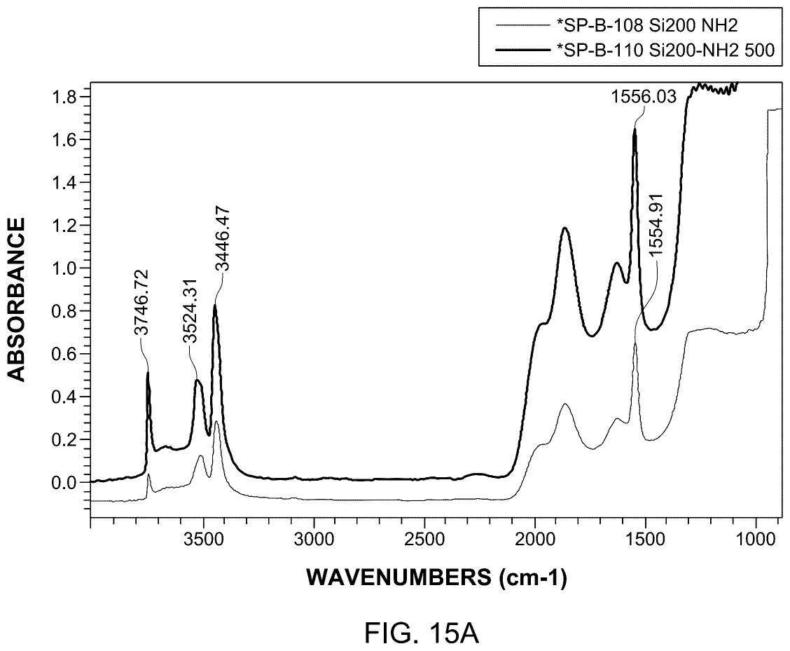

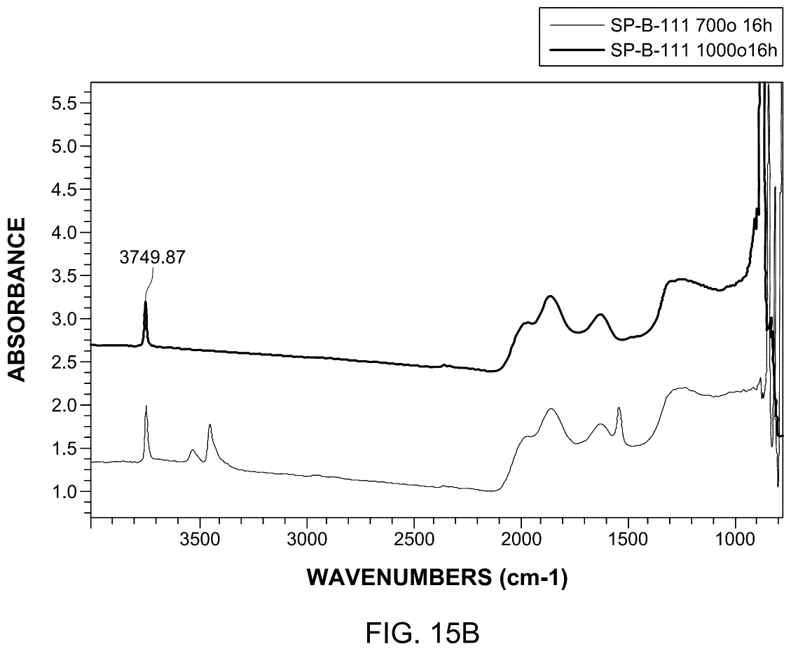

The inventors have observed that the entire deamination process leads to the recovery of the carriers 100 without notable structural changes. It was further observed that the recovery of the ammonia is about 80-90%, as discussed later with regard to the elemental analysis of the nitrogen content before and after deamination. The deamination process was followed by FT-IR spectroscopy and the typical spectra of NH₂—SiO₂²⁰⁰ before and after deamination are shown in FIGS. 15A and 15B, respectively, where the FT-IR bands characteristic of the silyl amine totally disappeared. FIG. 15A highlights the thermal stability of these silyl amines as no significant change in the IR spectrum was observed even after heating the product at 500° C. for 16h. FIG. 15B shows the complete deamination of the silica materials when heated at about 1000° C.

An elemental analysis was performed on the various samples to determine the nitrogen content of the silica material before and after the deamination reaction. Elemental analysis of the product 500, before and after deamination process indicates that the content of nitrogen in carrier 100 (product 500) was 0.95 wt. % and 0.18 wt. % respectively. This experiment shows the reduction in nitrogen content of carrier 100 due to the release of ammonia via the condensation of silanol/silylamine pairs.

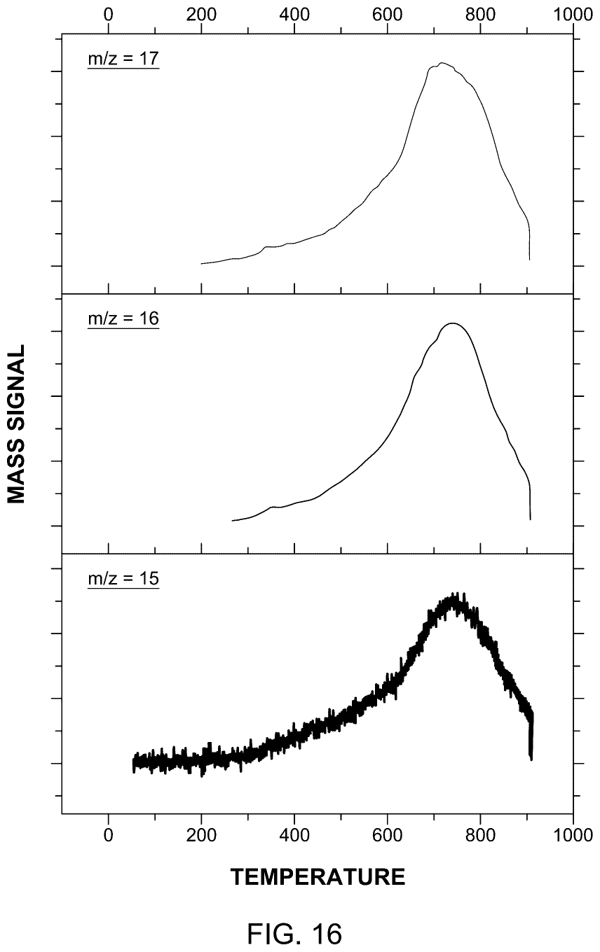

To further study and prove the ammonia release, TPD-MS analysis was performed in the presence of He as a carrier gas. Carrier 100 for product 500 was heated at a range of temperatures and the released gases were analyzed using a mass detector. The obtained data is presented in FIG. 16, which shows peaks for ammonia release. The TPD-MS data shows a 42% release of nitrogen. However, the deamination process needs to be performed under high vacuum for a complete desorption of the ammonia. The TPD-MS analysis was used for qualitative release of ammonia to highlight the thermal stability of the Si—NH₂ bond versus the physisorption process. For a quantitative release, the elemental analysis is more precise.

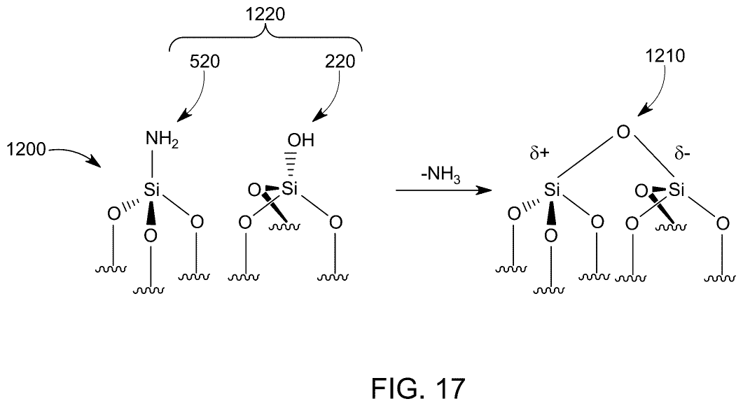

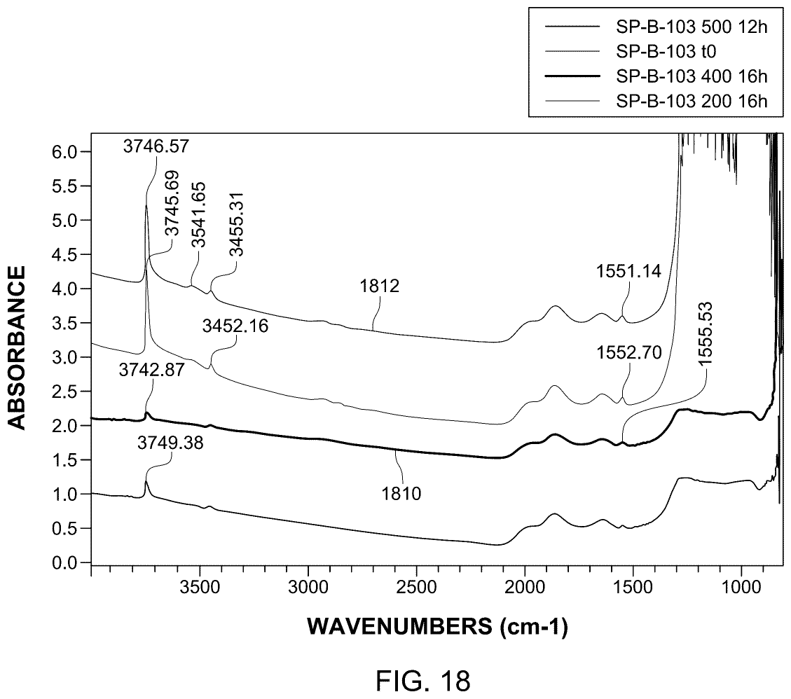

The deamination of product 1200 is schematically illustrated in FIG. 17. The pair 1220 of silyamine silanol corresponds to the elimination of one molecule of ammonia, and it occurs at a moderate-temperature range (400° C.) under a high vacuum for 16 hours. A strained siloxane bridge 1210 is formed in addition to the ammonia molecule. The deamination process illustrated in FIG. 17 was monitored by FT-IR spectroscopy at different temperatures, as illustrated in FIG. 18. A drastic decrease of the characteristic bands of silanol and silylamine group occur at 400° C., see curve 1810 in the figure. Note that curve 1812 indicates the spectrum of the product 1200 before deamination.

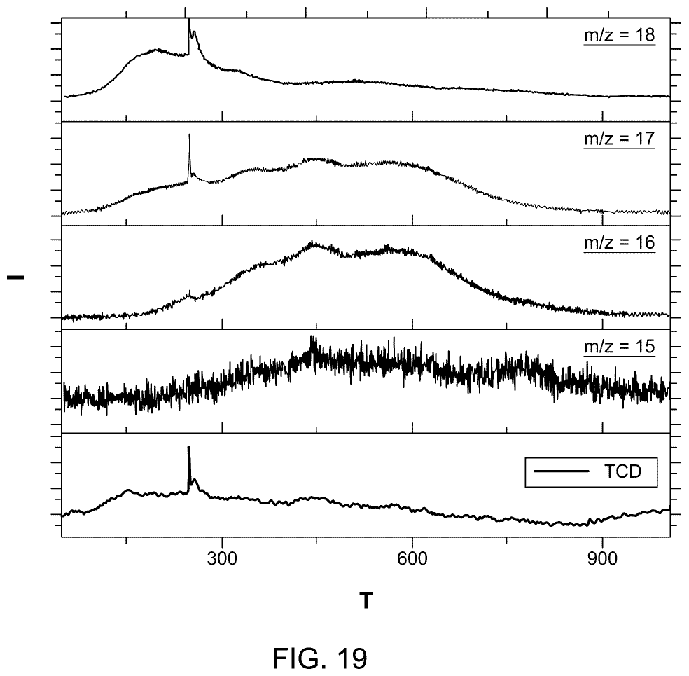

In addition, the nitrogen content of the silica material (in this particular case, mesoporous silica, i.e., SBA-15) was monitored before and after the reaction. The elemental analysis of the material 1200 before and after the deamination process revealed that the content of the nitrogen was 0.58 wt. % and 0.08 wt. % before and after deamination, respectively. This experiment also shows the reduction in the nitrogen content in product 1200 due to the release of ammonia via the condensation of silanol/silyl amine pairs. TPD-MS experiments in the presence of He as carrier gas were also performed. The product 1200 was heated at a range of temperatures and the released gases were analyzed using a mass detector. FIG. 19 shows the mass data and temperature of the desorption of ammonia for material 1200. As can be observed from the curves corresponding to the m/z ratio (where m is the mass and z is the charge number of ions) 16 and 17, the ammonia desorption begins at about 300° C. and lasts untill 700° C. At mass 18, mainly a peak for the water was observed.

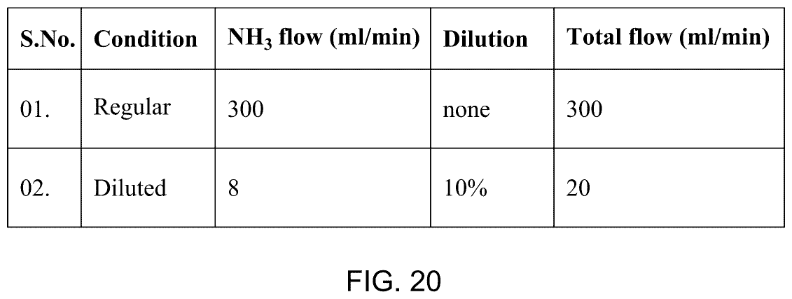

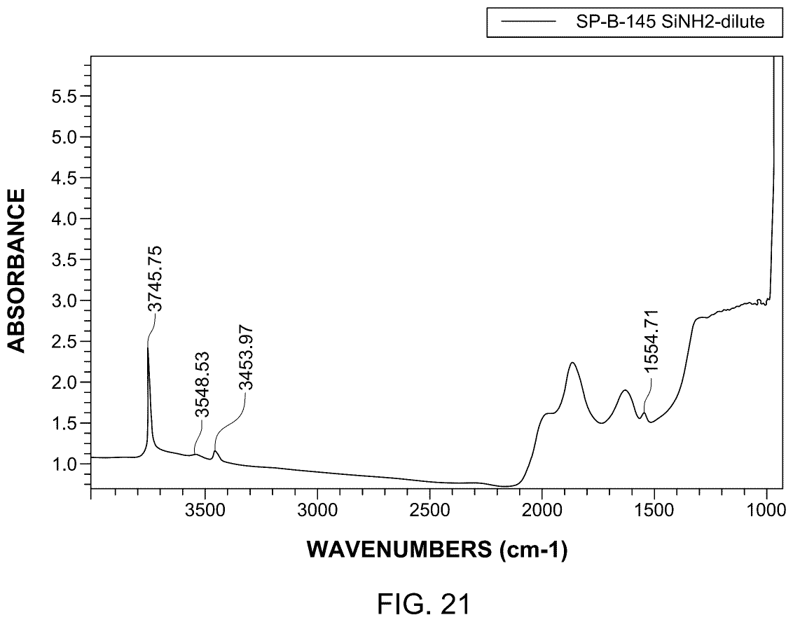

In an effort to make one or more of the processes discussed above more economical and/or to target more industrial applications of the process (e.g., gas purification, fuel cell, etc.), the inventors have tried the ammonification of silica under significantly diluted conditions, as illustrated in the second row of the table in FIG. 20. In an experiment, silica dehydroxylated at 1000° C. (Si₁₀₀₀) was reacted with 10% NH₃ (diluted with helium) at 400° C. for 5h (total flow 20 ml/min). It was then cooled to RT in N₂ (total flow 60 ml/min). The inventors observed the unexpected results of silyl amine formation, as confirmed by the FT-IR spectrum in FIG. 21, which showed the presence of characteristic silyl amine signals. The N content analysis showed 0.13 wt. % nitrogen content. Thus, in one embodiment, it is possible to dilute the flow of NH₃ to be about one tenth or lower than the flows discussed above.

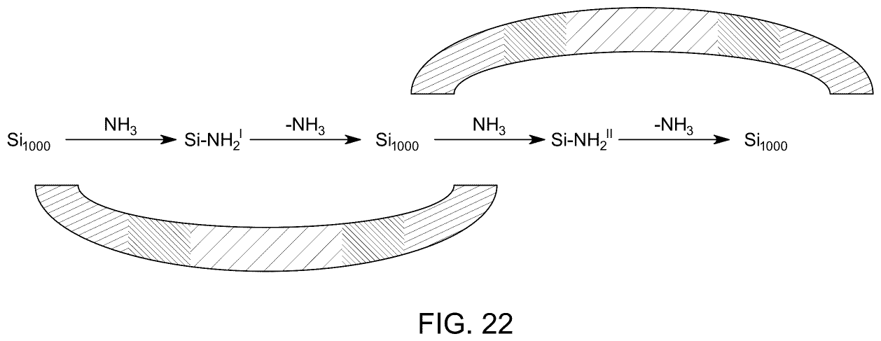

To test the recyclable nature of the carrier 100 (i.e., the capacity to load and unload the carrier with the amine groups), a recyclability test was performed in an amination-deamination-reamination-deamination sequence, as schematically illustrated in FIG. 22. The results showed that the material is recyclable for at least 2 cycles without any noticeable changes in the structural framework, as confirmed by FT-IR and elemental analysis data.

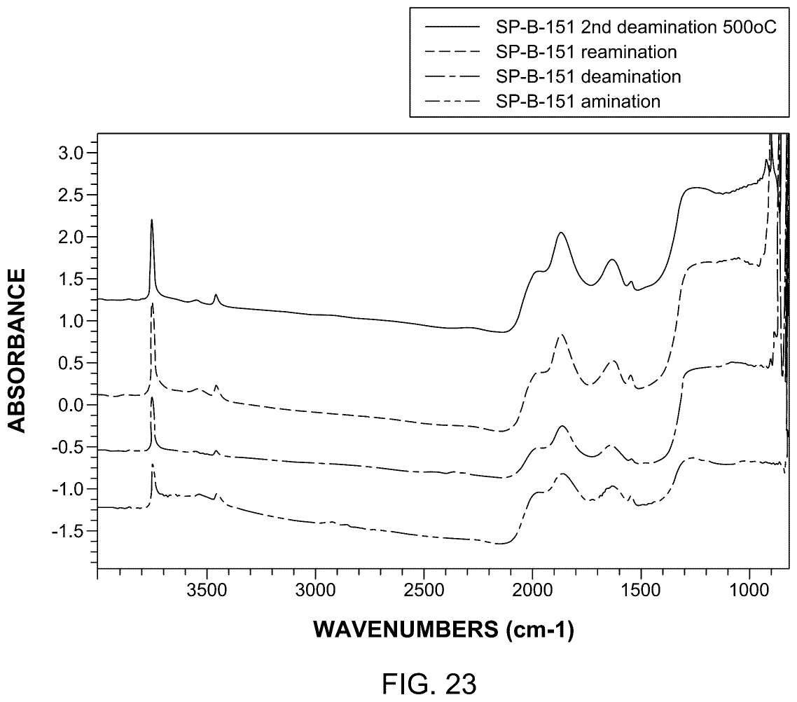

In a series of FT-IR experiments, during amination, vibrational bands characteristic of the silyl amine group, i.e., asymmetric stretching vibrational bands at 3509 (vₐₛ(NH₂)), symmetric stretching vibrational bands at 3442 (vₛ(NH₂)) along with bending vibrational band at 1554 (δ(NH₂)) were observed, as illustrated in FIG. 23, and these peaks disappeared after the deamination step, as also illustrated in the figure. During the reamination step, the same bands reappeared, and then they disappeared in the second deamination step. These observations confirm the recyclability of the considered carriers.

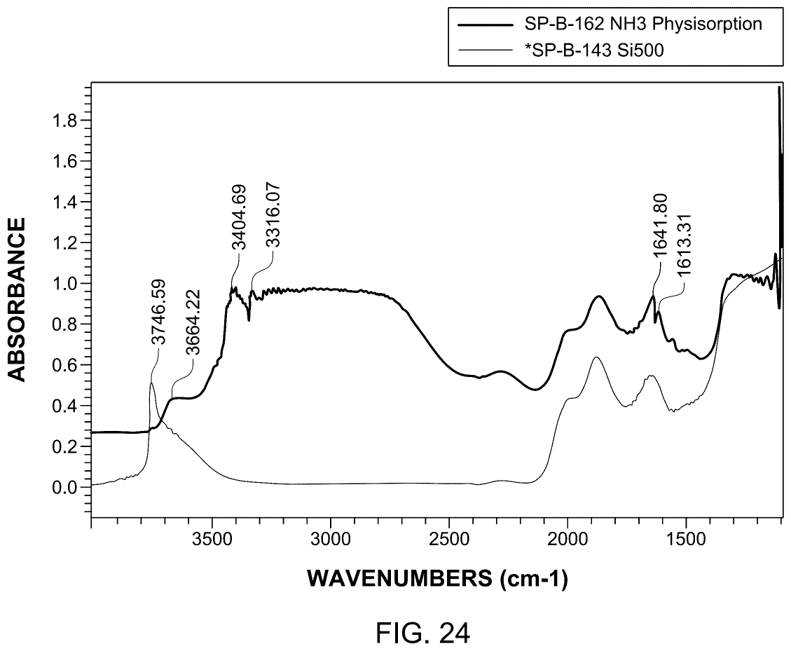

As previously discussed, the specific conditions for deamination that make this path very safe for amine transportation, are due to the chemisorption of the ammonia, and not physisorption as in the traditional approaches. To rule out the possibility of ammonia physisorption, a controlled experiment was performed. According to this experiment, ammonia was physisorbed on silica (dehydroxylated at 500° C.) at RT and the reaction was followed by FT-IR analysis, as illustrated in FIG. 24. The FT-IR spectra of the physisorbed samples show vibrational bands at 3404, 3316 and 1640 cm⁻¹, which is similar to the literature reported values for physiosorbed ammonia (see, for example, Ref. Can. J. Chem. 1973, 51, 1771). Moreover, a red shift in the silanol signal from 3746 to 3664 cm⁻¹ was observed, possibly due to the hydrogen bonding interactions between the ammonia and the surface silanol groups. In general, signals obtained in physisorbed ammonia case were relatively broad and not very well defined as in case of ammonia chemisorbed shown, for example, in FIG. 9.

These experiments confirm that the inventors developed an effective method to design carriers that are capable of storing ammonia in the form of silyl amine groups. It was demonstrated that the release of ammonia is possible under controlled and safe conditions, which are very hard to replicate during natural conditions when the ammonia is transported to a desired destination, which makes its transportation very safe. The technology discussed herein is highly versatile in nature and applicable to many areas of chemical sciences, particularly to those dealing with ammonia. Some of the possible applications are as follows: (1) safe transport of ammonia, (2) less hazardous method to store and recycle ammonia, (3) increasing the turnover number of the catalyst in the Haber-Bosch process (shifting the reaction equilibrium), (4) removal of ammonia in applications where ammonia acts as a poison, (5) Hydrogen carrier, as ammonia cracking leads to H2 production (6) fuel cell applications as traces of ammonia, and long exposure periods, resulted in severe and irreversible losses of the fuel cell performance (7) selective catalytic reduction of harmful NOₓ and SOₓ to green gases, (8) gas separation, and (9) use as ammonia based fertilizers. This is not an exclusive list for the application of the processes and carriers discussed above, as those skilled in the art would be inspired to apply these processes to other fields that use ammonia.

The disclosed embodiments provide carriers and methods for loading the carriers with amine groups so that a transport of the nitrogen atoms is achieved with high safety. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### References

The entire content of all the publications listed herein is incorporated by reference in this patent application.
[1] U.S. Pat. No. 9,272,262;
[2] R. Roque-Malherbe et al., Ammonia Adsorption on Nanostructured Silica Materials for Hydrogen Storage and Other Applications, J. Nanosci. Nanotechnol., 2008, Vol. 8. No. 11; and
[3] A. Bendjeriou-Sedjerari et al., A well-defined mesoporous amine silica surface via a selective treatment of SBA-15 with ammonia, Chem. Commun., 2012, 48, 3067-3069.

1. An amine-loaded carrier loaded with silyl amine groups, the amine loaded carrier comprising:
a non-porous silica substrate dehydrated or dehydroxylated at a first temperature; and
the silyl amine groups attached to the dehydrated, non-porous silica substrate at a second temperature, different from the first temperature, so that covalent bonds are formed between a surface of the non-porous silica substrate and the silyl amine groups,
wherein the covalent bonds are formed due to a chemisorption process, and the covalent bonds are stronger than van der Waals bonds formed due to a physisorption process.

2. The carrier of claim 1, wherein vicinal silyl amine groups replace vicinal silanol groups and single silyl amine groups replace single silanol groups of the dehydrated non-porous silica substrate, after the second temperature is applied, and wherein the vicinal silanol groups are more than 75% by weight than a total weight of all silanol groups after the first temperature is applied.

3. The carrier of claim 2, wherein a distance between two adjacent vicinal silanol groups is smaller than 5 Å and a distance between two adjacent single silanol groups is larger than 5 Å.

4. The carrier of claim 1, wherein vicinal silyl amine groups replace vicinal silanol groups, and single silyl amine groups replace single silanol groups of the dehydrated non-porous silica substrate, after the second temperature is applied, and wherein the vicinal silanol groups and the single silanol groups, which are formed after the first temperature is applied, are present in a 1:1 ratio.

5. The carrier of claim 4, wherein siloxane bridges are formed by the silanol groups prior to being replaced by the silyl amine groups.

6. The carrier of claim 1, wherein only single silanol groups are present on the substrate after the first temperature is applied.

7. The carrier of claim 6, wherein the single silanol groups are replaced by single silyl amine groups after the second temperature is applied.

8. The carrier of claim 1, wherein silanol groups are replaced by strained silanol bridges on the substrate after the first temperature is applied.

9. The carrier of claim 7, wherein the strained silanol bridges are opened due to the second temperature and the strained silanol bridges are replaced by silyl amine groups.

10. The carrier of claim 1, wherein no porosities are formed into the non-porous silica substrate.

11. A method for transporting amine groups, the method comprising:
dehydrating or dehydroxylating a non-porous silica carrier at a first temperature; and
loading the non-porous silica carrier with silyl amine groups, at a second temperature, different from the first temperature, and under vacuum, in presence of an ammonia flow so that covalent bonds are formed between a surface of the non-porous silica carrier and the silyl amine groups,
wherein the covalent bonds are formed due to a chemisorption process that happens at the second temperature and the vacuum condition, and the covalent bonds are stronger than van der Waals bonds formed due to a physisorption process.

12. The method of claim 11, wherein the step of dehydrating generates vicinal silanol groups and single silanol groups, and the step of loading replaces the vicinal silanol groups with vicinal silyl amine groups, and replaces the single silanol groups with single silyl amine groups, and wherein the vicinal silanol groups are more than 75% by weight than a total weight of all silanol groups after the first temperature is applied.

13. The method of claim 12, wherein the first temperature is about 200° C., the second temperature is about 500° C., a distance between two adjacent vicinal silanol groups is smaller than 5 Å, and a distance between two adjacent single silanol groups is larger than 5 Å.

14. The method of claim 11, wherein the step of dehydroxylation takes place at about 500° C. and results in the formation of vicinal silanol groups and single silanol groups on a surface of the carrier, and the step of loading at the second temperature of about 500° C. results in replacing the vicinal silanol groups with vicinal silyl amine groups, and replacing the single silanol groups with single silyl amine groups, and wherein the vicinal silanol groups and the single silanol groups are formed in a 1:1 ratio by mass.

15. The method of claim 14, wherein siloxane bridges are formed by the silanol groups prior to being replaced to the silyl amine groups.

16. The method of claim 11, wherein the step of dehydroxylating at the first temperature of about 700° C. results in only single silanol groups being formed on a surface of the carrier.

17. The method of claim 16, wherein the step of loading at the second temperature of about 500° C. results in the single silanol groups being replaced with single silyl amine groups.

18. The method of claim 11, wherein the step of dehydroxylating at the first temperature of about 1100° C. results in silanol groups being replaced by strained silanol bridges on the carrier.

19. The method of claim 18, wherein the step of loading at the second temperature of about 200° C. results in the strained silanol bridges being opened and the strained silanol bridges being replaced by silyl amine groups. Page 10

20. The method of claim 11, further comprising:
deaminating the silyl amine groups at a temperature between 400 to 900° C., in vacuum at about 10⁻⁶ to 10⁴ mbar, for about 16 h, to generate ammonia.
